(19) United States
(12) Patent Application Publication
(10) Pub. No.: US 2009/0279296 A1
(43) Pub. Date: Nov. 12, 2009

(54) LIGHT EMITTING DIODE LAMP

(75) Inventor: Chia-Shou Chang, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/399,026

(22) Filed: Mar. 6, 2009

(30) Foreign Application Priority Data
May 9, 2008 (CN) 200810067116.1

(51) Int. Cl. F21V 1/00

(52) U.S. Cl. 362/235

(57) ABSTRACT

An LED lamp includes an LED, a reflector, a first lens and a second lens. The reflector includes an outer surface which is a total reflective surface. A receiving space extends into the reflector from a center of a top side of the reflector and defines an opening in the center of the top side. The LED is received in the receiving space and faces the top side of the reflector. The first lens couples to and seals the opening of the reflector. The second lens is arranged on the top side of the reflector surrounding the first lens. Light generated by the LED passes across both of the first and second lenses to an exterior during operation of the LED lamp.

### BACKGROUND

1. Technical Field

The disclosure generally relates to light emitting diode lamps, and particularly to a light emitting diode lamp with a uniform light distribution.

2. Description of Related Art

In recent years, light emitting diodes (LEDs) have been widely used in illumination. However, the LED is a point light source, and an emitting surface thereof is usually hemispherical. Intensity of a light field of the LED decreases gradually and outwardly along a radial direction thereof. The intensity of the light field of the LED is uneven, being strong at a center of the light field of the LED and weak at the periphery of the light field of the LED.

For the foregoing reasons, therefore, there is a need in the art for an LED lamp which overcomes the limitations described.

### BRIEF DESCRIPTION OF THE DRAWINGS

FIG. 1 is an isometric, assembled view of a light emitting diode lamp according to an exemplary embodiment.

FIG. 2 is a cross-sectional view of the light emitting diode lamp of FIG. 1, taken along line II-II thereof.

FIG. 3 is a cross-sectional view of a reflector of the light emitting diode lamp of FIG. 1.

### DETAILED DESCRIPTION OF THE EMBODIMENTS

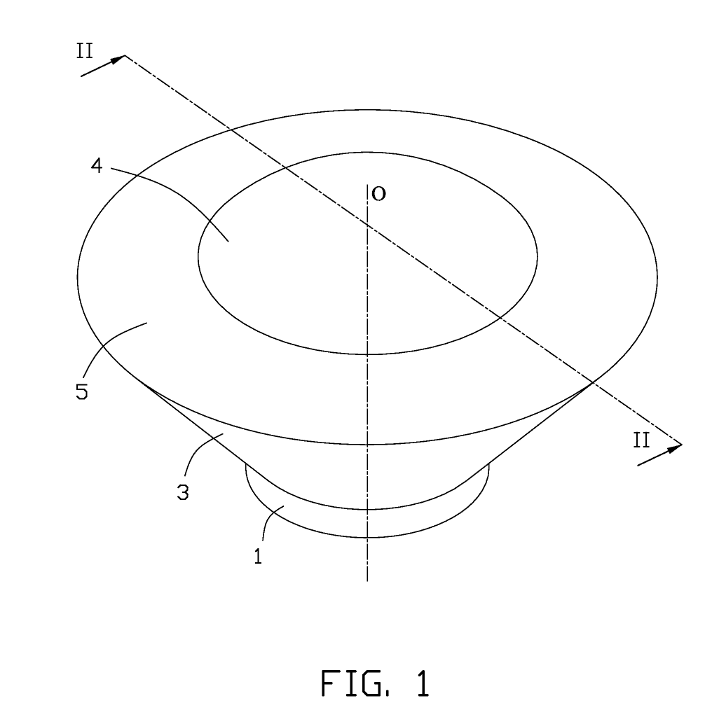

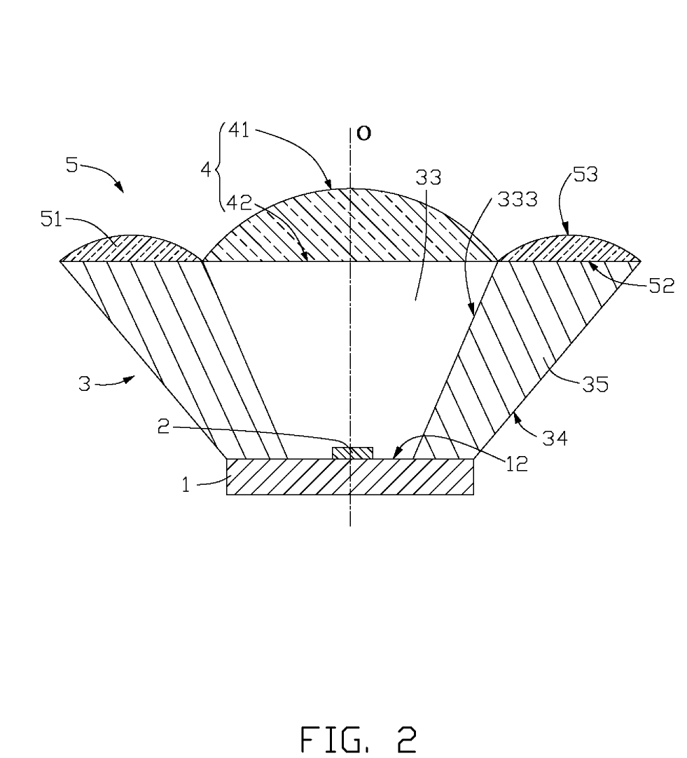

Referring to FIGS. 1 and 2, a light emitting diode (LED) lamp according to an exemplary embodiment includes a substrate 1, an LED 2, a reflector 3, a first lens 4, and a second lens 5.

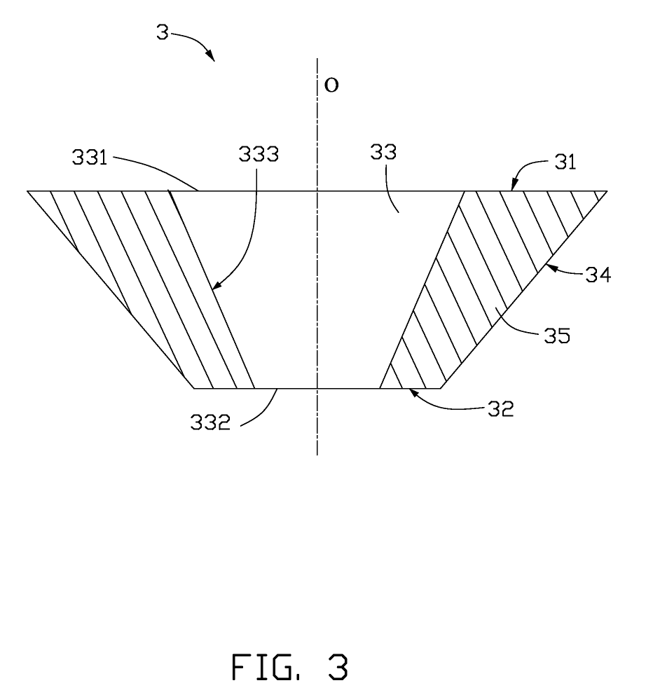

The reflector 3 is made of transparent material, such as resin, glass, silicone, epoxy, polymethyl methacrylate, and Polycarbonate. A penetration rate of the reflector 3 is not below 70%, and a refractive index of the reflector 3 is in range of 1.4˜1.7. Referring to FIG. 3, the reflector 3 is conversely truncated conical, which expands along an axis O thereof from a bottom side 32 to a top side 31 thereof. An outer surface 34 of the reflector 3 has a diameter increasing gradually from the bottom side 32 to the top side 31 of the reflector 3. The outer surface 34 of the reflector 3 is a total reflective surface, and thus light emitted from the LED 2 cannot escape from the reflector 3 through the outer surface 34 according to the principle of total internal reflection that when an angle of incidence of the light exceeds a critical value, the light will be completely reflected.

The reflector 3 defines a receiving space 33 therein. The receiving space 33 extends through the reflector 3 along the axis O of the reflector 3 from the bottom side 32 to the top side 31, and thus defines a top opening 331 and a bottom opening 332 in the top side 31 and the bottom side 32 of the reflector 3, respectively. Similarly, the receiving space 33 is conversely truncated conical and has a diameter gradually increasing along the axis O of the reflector 3 from the bottom opening 332 to the top opening 331. An inner surface 333 is formed in the reflector 3 surrounding the receiving space 33. Accordingly, a diameter of the inner surface 333 increases gradually from the bottom side 32 to the top side 31. A slope of the inner surface 333 is larger than that of the outer surface 34 of the reflector 3, and thus a width of a solid part 35 of the reflector 3 between the outer surface 34 and the inner surface 333 increases gradually along the axis O from the bottom side 32 to the top side 31. In other words, a thickness of a wall of the reflector 3 surrounding the receiving space 33 increases gradually along the axis O from the bottom side 32 to the top side 31.

Referring to FIG. 2 again, the substrate 1 couples to the bottom side 32 of the reflector 3 to seal the bottom opening 332 of the reflector 3. The substrate 1 is a circular plate, which has a diameter substantially equal to an outer diameter of the bottom side 32 of the reflector 3. The reflector 3 has a planar top surface 12. An outer periphery of the top surface 12 of the substrate 1 abuts against the bottom side 32 of the reflector 3. A central portion of the top surface 12 of the substrate 1 is surrounded by the reflector 3 and faces the receiving space 33 of the reflector 3. The LED 2 is arranged on the central portion of the upper surface 12 of the substrate 1.

The first lens 4 couples to and seals the top opening 331 of the reflector 3. Thus the LED 2 is sealed in the receiving space 33 of the reflector 3 by the substrate 1, the first lens 4 and the inner surface 333 of the reflector 3. The first lens 4 includes a bottom surface 42 facing the receiving space 33 and an opposite top surface 41 facing an exterior. The first lens 4 has a shape of a spherical cap; the bottom surface 42 of the first lens 4 is horizontal and has a diameter substantially equal to the diameter of the top opening 331 of the reflector 3. The top surface 41 of the first lens 4 is convex. A height of the convex top surface 41 of the first lens 4 decreases gradually and radially from a center of the convex top surface 41 which is located on the axis O of the reflector 3 to an outer periphery of the convex top surface 41. Thus the center of the convex top surface 41 of the first lens 4 has the maximum height of the first lens 4.

The second lens 5 is arranged on the solid part 35 of the reflector 3. The second lens 5 has a bottom surface 52 covering the entire top side 31 of the reflector 3, and a convex top surface 53 facing the exterior. In this embodiment, the second lens 5 and the first lens 4 are formed separately and then assembled together. Alternatively, the first lens 4 and the second lens 5 can be formed integrally. The second lens 5 is annular. An outer diameter of the bottom surface 52 of the second lens 5 is substantially equal to the diameter of the outer surface 34 of the reflector 3 at the top side 31, and an inner diameter of the bottom surface 52 of the second lens 5 is substantially the same as the diameter of the bottom surface 42 of the first lens 4 and the same as the diameter of the top opening 331. The second lens 5 is formed by rotating a circular segment 51 which is spaced from the axis O of the reflector 3 a distance equal to a radius of the top opening 331 around the axis O of the reflector 3. FIG. 2 shows that in a cross section view, a pair of circular segments 51 are located at two opposite sides of the first lens 4 symmetrically. A maximum height of the circular segment 51 which forms the second lens 5 is below the maximum height of the first lens 4. In other words, a maximum height of the second lens 5 is below than that of the first lens 4.

When the LED 2 emits light, a majority of the light of the LED 2 passes across the receiving space 33 of the reflector 3 and then across the first lens 4 to the exterior directly. In addition, remainder light of the LED 2 travels towards the inner surface 333 of the reflector 3 and enters into the solid part 35 of the reflector 3 through the inner surface 333. As the outer surface 34 of the reflector 3 is a total reflective surface, when the remainder light encounters the outer surface 34, all of the remainder light is reflected and can not escape from the reflector 3 through the outer surface 34. The remainder light in the solid part 35 of the reflector 3 is reflected towards the second lens 5, moves through the lens 5 and finally leaves the second lens 5 to the exterior. Thus all of the light of the LED 2, either through the first lens 4, or through the second lens 5, can reach the exterior. Furthermore, as the top surfaces 41, 53 of the first lens 4 and the second lens 5 are spherical, the light of the LED 2 is converted to be generally parallel light after across the first lens 4 and the second lens 5, such that the LED 2 acts as a surface light source. Intensity of the light field of the LED lamp is thus substantially even.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A light emitting diode lamp, comprising:
at least one light emitting diode;
a reflector having a bottom side, a top side opposite to the bottom side, and an outer surface interconnecting outer peripheries of the top side and the bottom side, the outer surface of the reflector being a total reflective surface, a receiving space extending into the reflector from a center of the top side of the reflector and defining an opening in the center of the top side, the at least one light emitting diode being received in the receiving space and facing the top side of the reflector;
a first lens coupling to the center of the top side of the reflector and sealing the opening; and
a second lens arranged on the top side of the reflector and surrounding the first lens, light generated by the at lease one light emitting diode passing across both of the first lens and the second lens to an exterior during operation of the light emitting diode lamp.

2. The light emitting diode lamp of claim 1, wherein the first lens has a shape of spherical cap, and comprises a planar bottom surface facing the receiving space and a convex top surface facing the exterior, a diameter of the bottom surface being substantially equal to that of the opening of the reflector.

3. The light emitting diode lamp of claim 2, wherein the second lens is annular, and has an inner diameter substantially equal to the diameter of the opening of the reflector, and an outer diameter substantially equal to an outer diameter of the top side of the reflector.

4. The light emitting diode lamp of claim 3, wherein the first lens and the second lens are integrally formed.

5. The light emitting diode lamp of claim 3, wherein the second lens is formed by rotating a circular segment around an axis which is spaced from the circular segment a distance substantially equal to a radius of the first lens.

6. The light emitting diode lamp of claim 3, wherein a maximum height of the second lens is smaller than that of the first lens.

7. The light emitting diode lamp of claim 1, wherein the reflector is conversely truncated conical, and the outer surface of the reflector has a diameter increasing gradually and upwardly along the axis thereof.

8. The light emitting diode lamp of claim 1, wherein the receiving space is conversely truncated conical, and has a diameter increasing gradually and upwardly along the axis of the reflector.

9. The light emitting diode lamp of claim 1, wherein a thickness of a wall of the reflector surrounding the receiving space thereof increases gradually and upwardly along the axis of the reflector.

10. The light emitting diode lamp of claim 1, wherein the receiving space extends through the reflector and defines a second opening at a center of the bottom side, the light emitting lamp further comprising a substrate coupling to the center of the bottom side of the reflector and sealing the second opening, the at least one light emitting diode being arranged on the substrate.

11. A light emitting diode lamp, comprising:
a light emitting diode;
a reflector receiving the light emitting diode therein, the reflector having a hollow part and a solid part surrounding the hollow part, the light emitting diode being received in the hollow part;
a first lens sealing a side of the hollow part of the reflector opposite to another side of the hollow part at which the light emitting diode is located; and
a second lens attaching to the solid part of the reflector, light of the light emitting diode entering into the solid part of the reflector being reflected by an outer surface of the reflector to the second lens, from which the light enters an exterior during operation of the light emitting diode lamp.

12. The light emitting diode lamp of claim 11, wherein the reflector is made of transparent material, and has a penetration rate not below 70% and a refractive index in range of 1.4˜1.7.

13. The light emitting diode lamp of claim 12, wherein the reflector is one of resin, glass, silicone, epoxy, polymethyl methacrylate, and Polycarbonate.

14. The light emitting diode lamp of claim 12, wherein the outer surface of the reflector is a total reflective surface.

15. The light emitting diode lamp of claim 11, wherein the first lens has a shape of spherical cap, and the second lens is formed by rotating a circular segment around an axis which is spaced from the circular segment a distance substantially equal to a radius of the first lens.

16. The light emitting diode lamp of claim 15, wherein a maximum height of the second lens is smaller than that of the first lens.
